(19) United States
(12) Patent Application Publication
(10) Pub. No.: US 2023/0160675 A1
(43) Pub. Date: May 25, 2023

(54) Multipurpose Woodworking Gauge

(71) Applicant: Kenneth K. Redman, Fredonia, WI (US)

(72) Inventor: Kenneth K. Redman, Fredonia, WI (US)

(21) Appl. No.: 17/990,181

(22) Filed: Nov. 18, 2022

Related U.S. Application Data
(60) Provisional application No. 63/281,167, filed on Nov. 19, 2021.

(51) Int. Cl. G01B 3/20; B23Q 3/18

(52) U.S. Cl. CPC G01B 3/20; B23Q 3/186

(57) ABSTRACT

A woodworking gauge for use with a boring, drilling or cutting mechanism having a support surface and a cutting implement disposed on and extending through the support surface includes a pair of alignment blocks joined by a pair of connecting rods. The rods are slidably positioned within bores extending through each of the alignment blocks and can be fixed with regard to the alignment blocks by clamps disposed on the blocks. One alignment block includes a channel lock that is engaged with the support surface to secure the alignment block in a stationary position on the support surface. The remaining alignment block includes a cutting implement-engaging insert to be positioned against the boring, drilling or cutting blade. The position of the connecting rods extending past the alignment block engaged with the blade enables a cutting fence to be positioned to achieve the desired depth cut within the material workpiece.

### CROSS-REFERENCE TO RELATED APPLICATIONS

This application claims priority from U.S. Provisional Patent Application Ser. No. 63/281,167, the entirety of which is expressly incorporated herein by reference for all purposes.

### FIELD OF THE DISCLOSURE

The present disclosure relates generally to clamping devices, and more specifically to a woodworking gauge for aligning objects to be cut relative to the cutting implement to enable a desired cut to be made in the object or material.

### BACKGROUND OF THE DISCLOSURE

In the area of construction, often it is necessary to alter, cut or trim a piece of a construction material, such as wood, among others, in order to properly fit the construction material where necessary or desired. To accomplish this, many different styles and types of boring, drilling and/or cutting implements have been developed.

Some often utilized pieces of boring, drilling and/or cutting equipment include a support surface, such as a table on which the material to be cut can be placed, and a boring, drilling or cutting mechanism disposed within and extending above the support surface in order to be engageable with the material placed on the support surface. Devices of this type include table saws, band saws and drill presses, routing tables, cutting mechanisms having a metal or metallic support or non-metallic surface on which the material to be cut is positioned

One shortcoming with regard to devices of this type are issues with aligning a cutting guide or fence with the boring, drilling or cutting mechanism to achieve the desired bore, aperture or cut in the substrate material.

Therefore, it is desirable to develop an improved woodworking gauge for properly positioning a material guide or fence from the boring, drilling or cutting mechanism to address these issues with the prior art.

### SUMMARY OF THE DISCLOSURE

According to one aspect of an exemplary embodiment of the invention, a woodworking gauge for use with a boring, drilling or cutting mechanism having a support surface and a cutting implement disposed on an extending through the support surface includes a pair of alignment blocks joined by a pair of connecting rods. The rods are slidably positioned within bores extending through each of the alignment blocks and can be fixed with regard to the alignment blocks by clamps. One of the alignment blocks includes a positioning or locking insert that is engaged with the support surface to secure the alignment block in a stationary position on the support surface. The remaining alignment block includes a blade engaging insert to be positioned against the boring, drilling or cutting blade. The position of the connecting rods extending past the alignment block that is engaged with the blade enables a cutting fence to be positioned a desired distance from the blade to achieve the desired cut within the material workpiece.

These and other aspects, features and advantages of the invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is a top plan view of the woodworking gauge on a support surface according to an exemplary embodiment of the disclosure;

FIG. 2 is a side elevational view of the woodworking gauge of FIG. 1.

FIG. 3 is a rear elevational view of the woodworking gauge of FIG. 1.

FIG. 4 is an isometric view of the woodworking gauge of FIG. 1 including a large diameter router insert.

FIG. 5A is an isometric view of the insert of FIG. 4.

FIG. 5B is a top plan view of the insert of FIG. 5A.

FIG. 5C is a side elevational view of the insert of FIG. 5A.

FIG. 6 is an isometric view of the woodworking gauge of FIG. 1 including a small diameter router insert.

FIG. 7A is an isometric view of the insert of FIG. 6.

FIG. 7B is a top plan view of the insert of FIG. 7A.

FIG. 7C is a side elevational view of the insert of FIG. 7A.

FIG. 8 is an isometric view of the woodworking gauge of FIG. 1 including a band saw insert.

FIG. 9A is an isometric view of the insert of FIG. 8.

FIG. 9B is a top plan view of the insert of FIG. 9A

FIG. 9C is a side elevational view of the insert of FIG. 9A.

### DETAILED DESCRIPTION OF THE DRAWINGS

Before the present compositions, apparatuses and methods are described, it is understood that this invention is not limited to the particular embodiments and methodology, as these may vary. It is also to be understood that the terminology used herein is for the purpose of describing particular exemplary embodiments only, and is not intended to limit the scope of the present invention which will be limited only by the appended claims.

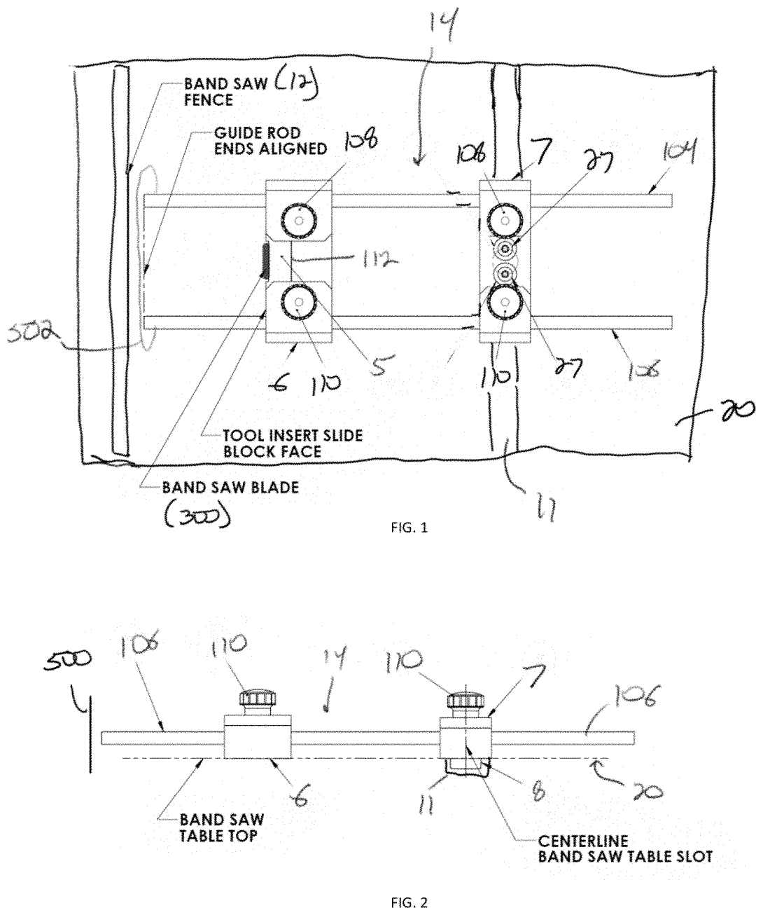

With reference now to FIGS. 1-3 an exemplary embodiment of a woodworking gauge is illustrated generally at 14. The gauge 14 is releasably securable to a support surface 20, such as a metal table saw, band saw or router saw support surface, and includes a first alignment block 6 and a second alignment block 7. The blocks 6, 7 are formed from a rigid material and each include a pair of spaced horizontal bores 100 and a pair of spaced vertical bores 102 extending therethrough.

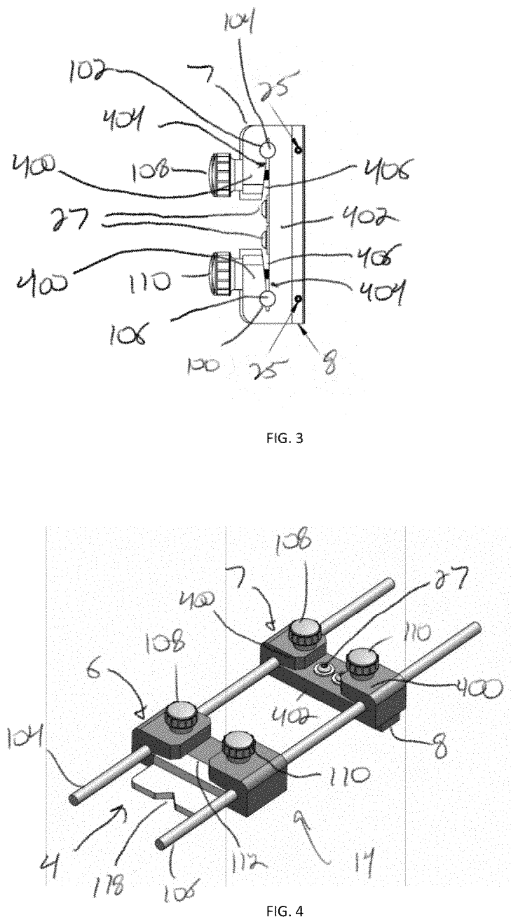

A pair of connecting rods 104,106 are slidably disposed within the horizontal bores 100 such that the blocks 6, 7 can be moved along the rods 104,106. The blocks 6,7 also include clamps 108,110 that can engage the blocks 6,7 with the rods 104,106 to secure the bocks 6,7 in the desired position on the rods 104,106. In one exemplary embodiment of the invention, the rods 104,106 can be fixed with regard to each of the alignment blocks 6,7 by threaded clamps 108,110 disposed within the complementary threaded vertical bores 102. As best shown in the illustrated exemplary embodiment of FIG. 3, the horizontal bores 100 are formed in the folds of inwardly extending flaps 400 joined to a base member 402 to form each of the blocks 6,7. Further, the flaps 400 define a space 404 between the flaps 400 and the base member 402, and the vertical bores 102 extend through the flaps 400 to intersect the space 404 and continue into the base member 402. In the illustrated exemplary embodiment of FIG. 3, the space 404 includes horizontal bores 100 in which the rods 104,106 are positioned and a narrow portion 406 that extends away from the bore 100 and across which the clamp 108,110 extends between the flaps 404 and the base member 402. In this manner, the threaded clamps 108,110 engaged in the vertical bores 102 across the space 404 can secure the rods 104,106 within the horizontal bores 100 by pulling the flaps 400 towards the base member 402 using the threaded engagement of the clamps 108,110 with the bores 102 and compressing the rods 104,106 between the flaps 400 and the base member 402.

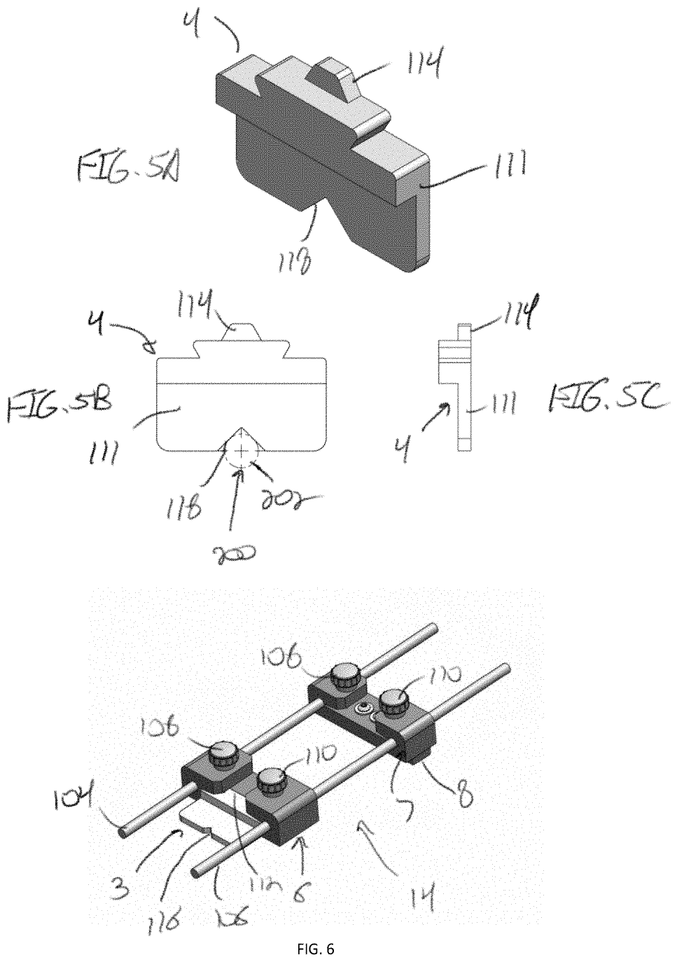

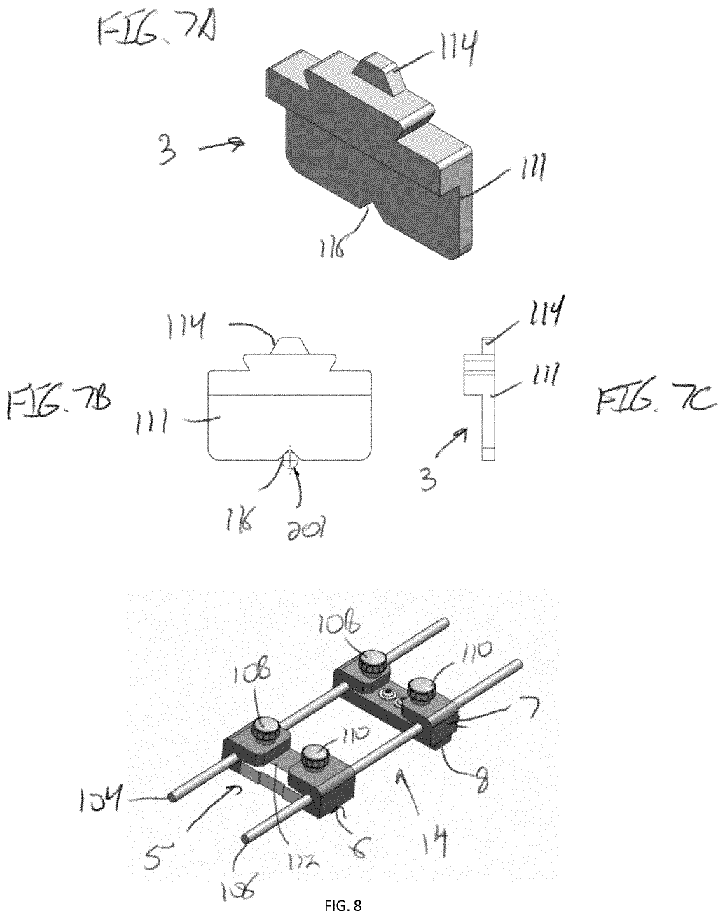

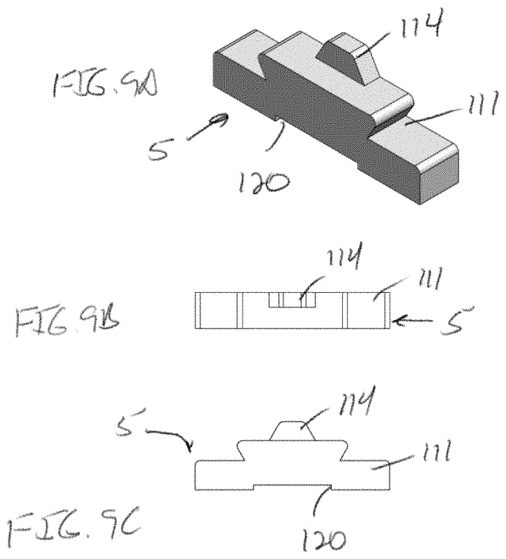

Referring now to the illustrated exemplary embodiments of FIGS. 4-8C The first alignment block 6 includes a notch 112 disposed on one side which receives one of a number of cutting implement-engaging inserts 3,4,5 shown in FIGS. 5A-5C, 7A-7C and 9A-9C., respectively. Each insert 3, 4, 5 includes a tab 114 on one side of a body 111 that is engageable within the notch 112 to secure the insert 3,4,5 to the first alignment block 6. Opposite the tab 114, the body 111 of the insert 3 in FIGS. 7A-7C includes a cutout 116 adapted to receive one half a small diameter shaft 201, the insert 4 includes a cutout 118 adapted to receive one half a large diameter shaft 202 of a router 200 (FIGS. 5A-5C), and the insert 5 includes a recess 120 adapted to receive one half of the thickness of a band saw blade 300 (FIGS. 9A-9C). In an alternative embodiment, the insert 5 can have a recess 120 adapted to receive the full thickness of the saw blade 300. For each insert 3,4,5, the size of the body 111 and the cutout 116,118,120, varies to accommodate the associated cutting implement.

Looking now at FIGS. 3, 4, 6 and 8, in order to securely position the gauge 14 on the support surface 20, a channel lock 8 that is adapted to be positioned and engaged within a complementary shaped channel 11 formed in the support surface 20 is fixed to the base member 402 of the second block 7 opposite the flaps 400, such as by a number of screws 27 engaged between the base member 402 and the channel lock 8. The channel lock 8 is positioned within the channel 11 when the gauge 14 is disposed on the support surface 20 in order to engage the channel 11 and retain the second block 7 in a stationary position on the support surface 20. The channel lock 8 additionally includes a number of set screws 25 disposed within bores on one or both sides of the channel lock 8, as shown in FIG. 3. The set screws 25 can be rotated relative to the channel lock 8 to protrude outwardly from the channel lock 8 in order to enable the channel lock 8 to more closely conform to the dimensions of the channel 11, and thus more securely hold the second block 7 and the gauge 14 on the support surface 20. In an alternative exemplary embodiment, the second block 7 includes a lower recess or notch 120 in which can releasably be disposed the channel lock 8 for engagement with the channel 11 in the support surface 20.

To use the gauge 14, initially the clamps 108,110 are disengaged to enable the blocks 6,7 to slide along the rods 104,106. The gauge 14 is then positioned on or against a flat surface, such as vertically on the support surface 20 or horizontally against a cutting fence 12 disposed on the support surface 20, to align the one end of each of the rods 104,106 with the edge of the first block 6. The second block 7 is then slid along the rods 104,106 to space the second block 7 away from the first block 6, and then is secured in the spaced position by engaging the clamps 108,110 on the second block 7 with the rods 104,106.

After securing the second block 7 to the rods 104,106, the gauge 14 is placed flat against the surface 20 in order to use a measuring device (not shown) to position the proper amount or length of each rod 104,106 beyond the first block 6. The length of the rods 104,106 extending beyond the first block 6 corresponds to the desired distance between the cutting implement, such as the band saw blade 300, and the depth or location for the cut to be made in the material being cut. Once the desired length of each rod 104,106 is positioned beyond the first block 6, the clamps 108,110 on the first block 6 are engaged with the rods 104,106 to affix the rods 104,106 relative to the first block 6.

After securing the first block 6 to define the desired cutting distance from the blade 300, the band saw insert 5 is secured to the first block 6, as shown in FIGS. 4, 6 and 8. Alternatively, the insert 5 can be engaged with the first block 6 prior to the alignment of the rods 104,106 with the first block 6. The clamps 108,110 in the second block 7 are then disengaged from the rods 104,106 to allow the second block 7 to slide along the rods 104,106.

The gauge 14 can then be placed on the support surface 20 with the rods 104,106 oriented parallel to the support surface 20 (FIG. 4) and the channel insert or lock 8 can be placed within the channel 11 formed in the support surface 20. The set screws 25 can be adjusted at this point in order to adjust or extend the cross-section, e.g., the width, of the channel lock 8 to enable the channel lock 8 to more closely fit within the channel 11, thereby more securely holding the lock 8 within the channel 11.

Once disposed in the channel 11, the rods 104,106 are slid with respect to the second block 7 in order to locate the first block 6 and insert 5 against the band saw blade 300, as shown in FIG. 1. In this position, the rods 104,106 extend past the blade 300 the required distance for the spacing of the cut to be made in the material.

After the first block 6 and insert 5 are positioned against the blade 300, the clamps 108,110 on the second block 7 are engaged with the rods 104,106 to lock the rods 104,106 in position relative to the channel 11. In this configuration, the rods 104,106 first block 6 and second block 7 are rigidly positioned on the support surface 20. The cutting fence 12 can then be positioned on the support surface 20 and moved into a location where the fence 12 contacts the ends of the rods 104,106 opposite the first block 6. In this position, the fence 12 defines a space between the fence 12 and the blade 300 corresponding to the desired distance or depth of the cut to be made in the material. The fence 12 is then locked to the support surface 20 to maintain the position of the fence 12 relative to the blade 300, and the gauge 14 can be removed from the support surface 20, such as by loosening one or more of the pairs of clamps 108,110 and lifting the channel lock 8 out of the channel 11, thus enabling the cutting device to be utilized to form the desired cut in the material workpiece.

If both rods 104,106 do not contact the fence 12 when the fence 12 is moved into contact with the rods 104,106, the screws 27 engaging the second block 7 with the channel lock 8 can be loosened in order to rotate the second block 7 with regard to the channel lock 8 in order to align the second block 7 with the channel lock 8 disposed within the channel 11 and/or the rods 104,106 with the table fence 12. Once aligned, the screws 27 are tightened to affix the second block 7 in alignment with the channel lock 8 and the channel 11 and/or the rods 104,106 with the fence 12.

When utilizing the gauge 14 to define a desired position for a cut in a material workpiece to be made using a router 200, the same process described previously can be utilized with the sole exception of the use of one of the inserts 3 or 4 to accommodate the diameter of the small diameter shaft 201 or the large diameter shaft 202 of the particular router 200. When utilizing the inserts 3 or 4, the distance that the rods 104,106 are positioned outwardly from the first block 6 is adjusted by the spacing of the cutouts 116 or 118 in the inserts 3 and 4.

Finally, in order to locate, align or set a table saw blade 500 vertically with regard to the support surface 20, a similar process to that described previously is utilized. After the rods 104,106 have been aligned with the first block 6, the second block 7 is slid away from the first block 6 and engaged with the rods 104,106 using the clamps 108,110. The gauge 14 can then be moved from the vertical position relative to the support surface 20 and placed with the rods 104,106 parallel to the support surface 20, and the first block 6 can then be slid along the rods 104,106 towards the second block 7 and engaged with the rods 104,106 using the clamps 108,110. The second block 7 then be engaged with the channel lock 8 and positioned over the channel 11 using the engagement of the lock 8 within the channel 17. This step is optional and can be omitted, particularly when the support surface 20 does not include a channel 11.

Once the second block 7 is aligned with the support surface 20 in a position that is parallel to the slot 502 in which the saw blade 500 is disposed, the rods 104,106 and first block 6 can be slide relative to the second block 7 until one or both of the rods 104,106 contact the saw blade 500. In this position, the saw blade 500 can be adjusted relative to the support surface 20 utilizing known adjustment mechanisms (not shown) on the support surface 20 to orient the saw blade 500 to vertically touch both rods 104,106, thereby aligning the saw blade 500 vertically with respect to the support surface 20.

The gauge 14 can also be used to align a table saw blade 500 and/or table saw fence 12 parallel to the table saw slot 502 and channel 11. First, the gauge 14 would first align the table saw blade 500 parallel to the table saw slot 502 and channel 11. To accomplish this, on the gauge 14 the rods 104, 106 are set with an equal distance extending from slide block 6. The slide block 6 is then clamped to rods 104, 106. The channel lock 8 is secured in the channel 11, with the rods 104, 105 are free to slide within slide block 7. The slide block 6 and rods 104, 106 are fixed together are slid forward until one or both rods 104,106 make contact with the table saw blade 500. The saw blade 500 is adjusted using the mechanism (not shown) on the table saw until the side of blade 500 makes contact with both rods 104, 106. The saw blade 500 is now positioned parallel to saw table slot 502 and the channel 11. Next, the table saw blade 500 is lowered below the surface of table/support surface 20. The fence 12 is subsequently slid towards rods 104, 106 until the fence side 12 contacts one or both rods 104, 106. If the fence 12 does not touch both rods 104, 106, the position of the fence 12 on the support surface 20 is adjusted until both rods 104,106 are in contact with the fence 12.

Various other embodiments of the present invention are contemplated as being within the scope of the filed claims particularly pointing out and distinctly claiming the subject matter regarded as the invention.

We claim:

1. A woodworking gauge comprising:
a) a first block
b) a second block; and
c) a pair of rods slidably interconnecting and engaged with each of the first block and the second block.

2. The woodworking gauge of claim 1, wherein the first block and the second block each comprise:
a) a base member; and
b) a pair of flaps operably connected to and extending over a portion of the base member, define a space between the base member and each of the pair of flaps.

3. The woodworking gauge of claim 2, wherein each of the pair of the flaps includes a clamp selectively engaged with the pair of rods.

4. The woodworking gauge of claim 3, wherein the space comprises:
a) a horizontal bore in which one of the pair of rods is positioned; and
b) a narrow portion extending away from the bore,
wherein the clamp extends between the flap and the base member across the narrow portion.

5. The woodworking clamp of claim 4, wherein the clamp is a threaded clamp.

6. The woodworking gauge of claim 1 further comprising a cutting implement-engaging insert releasably engaged with the first block.

7. The woodworking gauge of claim 6, wherein the cutting implement-engaging inserts each include a tab engageable within the first block and a cutout adapted to receive a portion of a cutting implement therein.

8. The woodworking gauge of claim 1 further comprising a channel lock releasably engaged with the second block.

9. The woodworking gauge of claim 8, wherein the channel lock is secured to the second block with a number of releasable fasteners.

10. The woodworking gauge of claim 8, wherein the channel lock includes a number of set screws disposed at least partially within the channel lock and selectively extendable from the channel lock to alter a width of the channel lock.

11. A method for aligning a workpiece relative to a cutting implement, the method comprising the steps of:
a) providing a woodworking gauge comprising:
i) a first block
ii) a second block;
iii) a pair of rods slidably interconnecting each of the first block and the second block; and
iv) at least one clamp on the first block and the second block to engage the first block and the second block with the pair of rods,
b) aligning ends of the pair of rods with the first block;
c) engaging the at least one clamp on the second block with the rods;
d) sliding the first block along the pair of rods to a desired distance from the ends of the pair of rods;
e) engaging the at least one clamp on the first block with the pair of rods;
f) engaging the second block with a support surface for the cutting implement; and
g) engaging a cutting guide disposed on the support surface with the ends of the pair of rods.

12. The method of claim 11, wherein the second block includes a channel lock thereon, and wherein the step of engaging the second block with the support comprises placing the channel lock within a channel formed in the support surface.

13. The method of claim 12, wherein the channel lock includes a number of set screws thereon, and wherein the step of placing the channel lock within the channel comprises:
a) adjusting the position of the set screws on the channel lock to approximate the size of the channel; and
b) positioning the channel lock within the channel.

14. The method of claim 11, further comprising the step of placing a cutting implement-engaging insert within the first block prior to sliding the first block along the pair of rods to a desired distance from the ends of the pair of rods.

15. A woodworking gauge comprising:
a) a first block
b) a second block;
c) a pair of rods slidably interconnecting and engaged with each of the first block and the second block;
d) a cutting implement-engaging insert releasably engaged with the first block; and
e) a channel lock releasably engaged with the second block.

16. The woodworking gauge of claim 15, wherein the first block and the second block each comprise:
a) a base member; and
b) a pair of flaps operably connected to and extending over a portion of the base member, define a space between the base member and each of the pair of flaps.

17. The woodworking gauge of claim 16, wherein each of the pair of the flaps includes a clamp extending through the flap and selectively engaged with the pair of rods.
